(19) United States
(12) Patent Application Publication
(10) Pub. No.: US 2019/0119535 A1
(43) Pub. Date: Apr. 25, 2019

(54) AQUEOUS ADHESIVE COMPOSITION COMPRISING A THERMOSETTING RESIN AND A LATEX

(71) Applicant: COMPAGNIE GENERALE DES ETABLISSEMENTS MICHELIN, CLERMONT-FERRAND (FR)

(72) Inventor: DAVID DOISNEAU, Clermont-Ferrand (FR)

(21) Appl. No.: 16/090,411

(22) PCT Filed: Apr. 3, 2017
(86) PCT No.: PCT/FR2017/050774

§ 371 Date: Oct. 1, 2018

(30) Foreign Application Priority Data
Apr. 1, 2016 (FR) 1652893

(51) Int. Cl. C09J 161/12; B60C 1/00

(52) U.S. Cl. CPC C09J 161/12; B60C 1/0008; C09J 2409/006; C09J 2400/266; B60C 1/0025

(57) ABSTRACT

An aqueous adhesive composition comprises A) a thermosetting resin and B) an unsaturated elastomer latex. The thermosetting resin is based on: at least one aromatic compound bearing at least two functions, one of these functions being a hydroxymethyl function and the other being an aldehyde function or a hydroxymethyl function, the aromatic compound comprising at least one aromatic ring; and at least aromatic polyphenol comprising at least one aromatic ring bearing at least two hydroxyl functions in the meta position relative to one another, the two positions ortho to at least one of the hydroxyl functions being unsubstituted; and/or at least one aromatic monophenol comprising at least one six-membered aromatic ring bearing a single hydroxyl function, the two positions ortho to the hydroxyl function being unsubstituted, or at least one position ortho to and the position para to the hydroxyl function being unsubstituted.

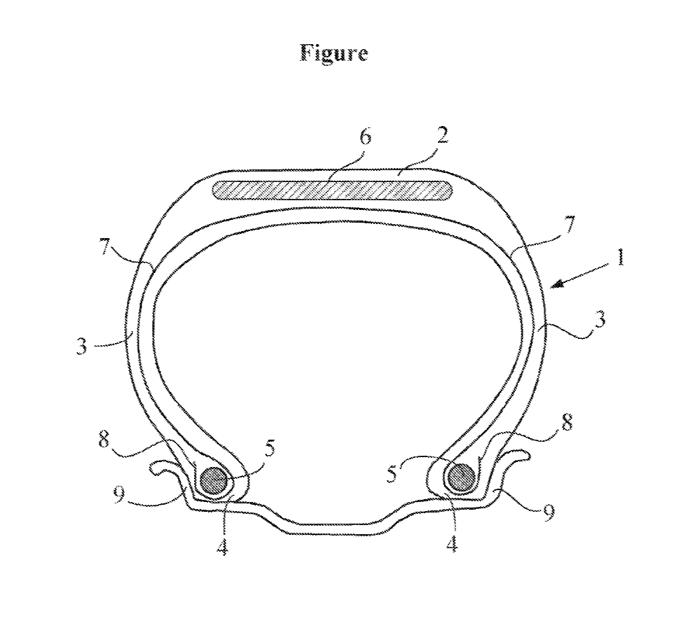

The field of the present invention is that of textile materials and adhesive compositions or “adhesives” intended to cause such textile materials to adhere to unsaturated rubber matrices, such as those commonly used in rubber articles or semi-finished products.

The present invention relates more particularly to textile materials sized with adhesive layers based on a thermosetting resin, especially to sized textile materials capable of reinforcing tyre structures.

Causing textile materials to adhere to diene elastomer compositions by virtue of the use of adhesives known under the name “RFL” (for resorcinol/formaldehyde latex), for example for the adhesive bonding of rubber compositions to textile cords made of polyester or polyamide, such as those customarily used in tyres, has been known for a very long time (see, for example, U.S. Pat. Nos. 2,561,215 and 3,817,778). These RFL adhesives comprise, in a well-known way, a thermosetting phenolic resin, obtained by the condensation of resorcinol with formaldehyde, and one or more latices of diene rubber in aqueous solution.

Experience shows that the above RFL adhesives confer excellent adhesion of textile materials to crosslinkable rubber compositions.

However, these RFL adhesives are not without disadvantage; in particular they comprise formaldehyde as base substance, which substance it is desirable in the long run to reduce in, or even to eliminate from, adhesive compositions because of the recent changes in European regulations regarding this type of compound.

Thus, the designers of rubber articles, especially tyre manufacturers, currently have the objective of finding novel adhesive systems or novel textile materials which make it possible to overcome the abovementioned disadvantage.

During their research, the Applicants have discovered an aqueous adhesive composition not using free formaldehyde which makes it possible to meet the above objective.

In their application WO2013/017421, the Applicants proposed aqueous adhesive compositions comprising on the one hand a phenol-aldehyde resin and on the other hand a latex.

The phenol-aldehyde resin is based on at least one polyaldehyde and a polyphenol. The presence of two aldehyde functions on the polyaldehyde is an essential characteristic that is necessary to ensure sufficient adhesive bonding.

The adhesive compositions described therein constitute a highly beneficial alternative to the use of conventional RFL adhesives.

However, the phenol-aldehyde resins described therein are sparingly water-soluble and require especially vigorous stirring during the addition thereof to the aqueous composition. This vigorous stirring requires costly apparatus and increases the duration of the process.

There is therefore a need for other alternative thermosetting resins which could effectively replace RFL adhesives.

Thus, a first subject of the invention relates to an aqueous adhesive composition comprising A) a thermosetting resin and B) an unsaturated elastomer latex, characterized in that the thermosetting resin is based on:
A1) at least one aromatic compound comprising at least one aromatic ring bearing at least two functions, one of these functions being a hydroxymethyl function and the other being an aldehyde function or a hydroxymethyl function; and
A2) at least one aromatic polyphenol comprising at least one aromatic ring bearing at least two hydroxyl functions in the meta position relative to one another, the two positions ortho to at least one of the hydroxyl functions being unsubstituted; and/or
A2′) at least one aromatic monophenol comprising at least one six-membered aromatic ring bearing a single hydroxyl function,
   the two positions ortho to the hydroxyl function being unsubstituted, or
   at least one position ortho to and the position para to the hydroxyl function being unsubstituted.

Another subject of the invention relates to an aqueous adhesive solution comprising a pre-condensed thermosetting resin based on:
A1) at least one aromatic compound comprising at least one aromatic ring bearing at least two functions, one of these functions being a hydroxymethyl function and the other being an aldehyde function or a hydroxymethyl function; and
A2) at least one aromatic polyphenol comprising at least one aromatic ring bearing at least two hydroxyl functions in the meta position relative to one another, the two positions ortho to at least one of the hydroxyl functions being unsubstituted.

Another subject of the invention relates to the use, for the adhesive bonding of a textile material to an unsaturated, and therefore crosslinkable, rubber, of the aqueous adhesive composition according to the invention or of the aqueous adhesive solution according to the invention and also a textile material, at least a portion of which is coated with an adhesive layer, characterized in that said layer comprises an aqueous adhesive composition according to the invention, a coated textile material obtained after drying, and a textile material obtained after crosslinking the thermosetting resin.

The invention also relates to a process for manufacturing a coated textile material according to the invention, characterized in that it comprises at least one step of coating the textile material with an adhesive composition in accordance with the invention, then a step of heating the coated textile material in order to crosslink the thermosetting resin.

The invention also relates to the use of the coated textile material of the invention as reinforcing element for rubber semi-finished products or articles, particularly tyres, especially those intended to equip motor vehicles of passenger type, SUVs (“Sport Utility Vehicles”), two-wheel vehicles (especially bicycles and motorcycles), aircraft, as well as for industrial vehicles chosen from vans, heavy-duty vehicles, that is to say, underground trains, buses, heavy road transport vehicles (lorries, tractors, trailers) or off-road vehicles, such as heavy agricultural vehicles or earthmoving equipment, or other transportation or handling vehicles.

The invention also relates, per se, to any rubber composite (semi-finished product or article), in particular any tyre, before and after curing (for final vulcanization or crosslinking), reinforced with a textile material according to the invention.

The invention and its advantages will be easily understood in the light of the following description and exemplary embodiments.

### I—Formulation of the Aqueous Adhesive Composition

In the present description, unless expressly indicated otherwise, all the percentages (%) shown are % by weight.

“Diene” elastomer (or, without distinction, rubber) is intended to mean an elastomer resulting at least in part (that is to say, a homopolymer or a copolymer) from diene monomer(s) (i.e., monomers bearing two conjugated or non-conjugated carbon-carbon double bonds). “Isoprene elastomer” is intended to mean an isoprene homopolymer or copolymer, in other words a diene elastomer selected from the group consisting of natural rubber (NR), synthetic polyisoprenes (IRs), various isoprene copolymers and the mixtures of these elastomers.

“Meta position relative to one another” is intended to mean that the functions in question, for example the hydroxyl functions in the aromatic polyphenol, are borne by carbons of the aromatic ring which are separated from one another by a single other carbon of the aromatic ring.

“Para position relative to one another” is intended to mean that the functions in question are opposite one another, that is to say in positions 1 and 4 of the 6-membered aromatic ring. Similarly, “the para position” relative to a function is a position opposite the function on the 6-membered aromatic ring bearing the function.

“Position ortho to a function” is intended to mean the position occupied by the carbon of the aromatic ring which is immediately adjacent to the carbon of the aromatic ring bearing the function. Similarly, “the ortho position” relative to a function is the position adjacent to the function on the aromatic ring bearing the function.

A “member” of a ring is intended to mean an atom constituting the backbone of the ring. Thus, for example, a benzene ring comprises six members, each member consisting of a carbon atom. In another example, a furan ring comprises five members, four members each consisting of a carbon atom and the remaining member consisting of an oxygen atom.

“CHO” represents the aldehyde function.

“CH₂OH” represents the hydroxymethyl function.

“Compound A1” denotes, within the context of the invention, the aromatic compound defined in paragraph I.1.

“Compound A2” denotes, within the context of the invention, the compound based on aromatic polyphenol defined in paragraph I.2.

“Compound A2′” denotes, within the context of the invention, the compound based on aromatic monophenol defined in paragraph I.2.

“Aromatic polyphenol” is intended to mean an aromatic compound comprising at least one benzene ring bearing more than one hydroxyl function.

Within the context of the invention, the carbon-based products mentioned in the description may be of fossil or biobased origin. In the latter case, they may partially or completely result from biomass or be obtained from renewable starting materials resulting from biomass.

Furthermore, any range of values denoted by the expression “between a and b” represents the range of values extending from more than a to less than b (that is to say, limits a and b excluded), while any range of values denoted by the expression “from a to b” means the range of values extending from a up to b (that is to say, including the strict limits a and b).

The expression “composition based on” should, of course, be understood as meaning a composition comprising the mixture and/or the reaction product of the various base constituents used for this composition, it being possible for some of them to be intended to react or capable of reacting with one another or with their immediate chemical surroundings, at least partly, during the various phases of manufacture of the composition, of the textile material or of the composites or finished articles comprising such composites, in particular during a curing step.

The aqueous adhesive composition according to the invention thus comprises at least, on the one hand, A) at least one (that is to say one or more) thermosetting resin according to the invention and, on the other hand, B) at least one (that is to say one or more) unsaturated elastomer latex; this thermosetting resin is, for its part, based on at least one (that is to say one or more) aromatic compound and at least one (that is to say one or more) aromatic polyphenol, which constituents will be described in detail below.

### I.1—Aromatic Compound A1

The first essential constituent of the thermosetting resin is an aromatic compound comprising at least one aromatic ring bearing at least two functions, one of these functions being a hydroxymethyl function and the other being an aldehyde function or a hydroxymethyl function. Thus, in accordance with the invention, it is said aromatic ring which bears hydroxymethyl and aldehyde functions. The compound according to the invention therefore corresponds to the general formula (I):

HO—CH₂—Ar—B (I)

wherein Ar represents an aromatic ring and B represents CHO or CH₂OH.

The aromatic ring is advantageously a 5- or 6-membered ring comprising, as members, carbon atoms and optionally one or more heteroatoms, in particular nitrogen, oxygen or sulfur atoms, optionally oxidized in N-oxide or S-oxide form. In one variant, the aromatic ring comprises 0, 1 or 2 heteroatom(s). The remainder of the aromatic ring may be substituted or unsubstituted.

The aromatic ring may bear 0, 1 or 2 aldehyde functions, advantageously 0 or 1 aldehyde function.

The aromatic ring may bear 1, 2 or 3 hydroxymethyl functions, advantageously 1 or 2 hydroxymethyl functions.

In addition, the aromatic ring may also bear 0, 1 or 2 other function(s), in particular hydroxyl.

In the embodiment in which the aromatic ring is a 6-membered ring, the B and hydroxymethyl functions are advantageously in the meta or para position relative to one another.

In the embodiment in which the aromatic ring is a 5-membered ring, the ring may comprise one or more heteroatoms, in particular nitrogen, oxygen or sulfur atoms, optionally oxidized in N-oxide or S-oxide form. Advantageously, the aromatic ring comprises 1 or 2 heteroatom(s), preferably 1 heteroatom.

In this embodiment, in which the aromatic ring is a 5-membered ring, at least one of the three following conditions is met:
the aromatic ring comprises 0 or a single aldehyde function;
the aromatic ring comprises one or two hydroxymethyl functions;
aside from the aldehyde and hydroxymethyl functions, the remainder of the aromatic ring is unsubstituted.

Advantageously, these three conditions are met.

In a first case, the aromatic ring comprises
a single aldehyde function;
a single hydroxymethyl function;
aside from the aldehyde and hydroxymethyl functions, the remainder of the aromatic ring is unsubstituted.

In a second case, the aromatic ring comprises
0 aldehyde functions;
two hydroxymethyl functions;
aside from the hydroxymethyl functions, the remainder of the aromatic ring is unsubstituted.

Advantageously, the compound is of general formula (II):

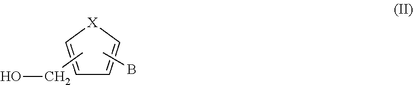

in which B represents CHO or CH₂OH, X represents O, NR₁, NO, S, SO, SO₂, SR₂R₃, R₁ represents a hydrogen, an alkyl, aryl, arylalkyl, alkylaryl or cycloalkyl group, R₂, R₃ each represent, independently of one another, a hydrogen, an alkyl, aryl, arylalkyl, alkylaryl or cycloalkyl group.

Advantageously, the compound is of general formula (II′):

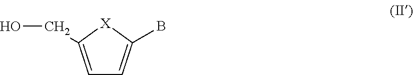

in which X and B are as defined above.

According to a particularly advantageous embodiment, B represents CHO. In another embodiment, B represents CH₂OH.

According to a preferential embodiment, X represents O.

In one variant, the compound is of formula (IIa):

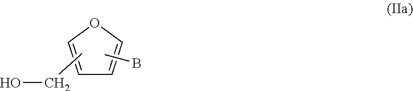

B being as defined above
and more particularly of formula (II′a1) or (II′a2):

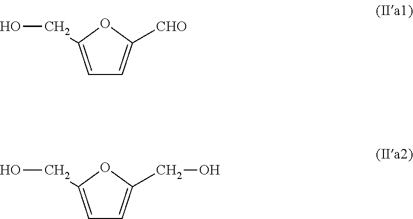 [SMILES: O=Cc1ccc(CO)o1 ; OCc1ccc(CO)o1]

5-(Hydroxymethyl)furfural (II′a1) is a particularly suitable aldehyde, given that this organic compound can be readily derived from renewable resources. Indeed, it is derived especially from the dehydration of certain sugars such as fructose, glucose, sucrose, cellulose and inulin.

In another embodiment, X represents NR₁ or NO, advantageously NR₁. R₁ is as defined above.

In one variant, the compound is of formula (lib):

B being as defined above

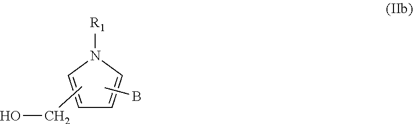

and more particularly of formula (II′b1) or (II′b2):

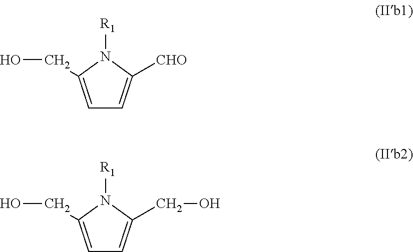

in which R₁ represents a hydrogen, an alkyl, aryl, arylalkyl, alkylaryl or cycloalkyl group. Advantageously, R₁ represents a hydrogen or a C₁-C₆ alkyl group.

In another embodiment, X represents S, SO, SO₂ or SR₂R₃.

In one variant, the compound is of formula (IIc):

B being as defined above

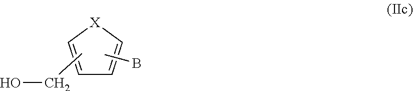

where X represents S, SR₂R₃, SO, SO₂, R₂, R₃ each represent, independently of one another, a hydrogen, an alkyl, aryl, arylalkyl, alkylaryl or cycloalkyl group, B being as defined above;
and more particularly of formula (II′c1) or (II′c2):

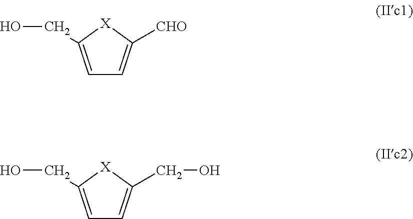

in which X represents S, SR₂R₃, SO, SO₂, R₂, R₃ each represent, independently of one another, a hydrogen, an alkyl, aryl, arylalkyl, alkylaryl or cycloalkyl group.

The compound may thus be:

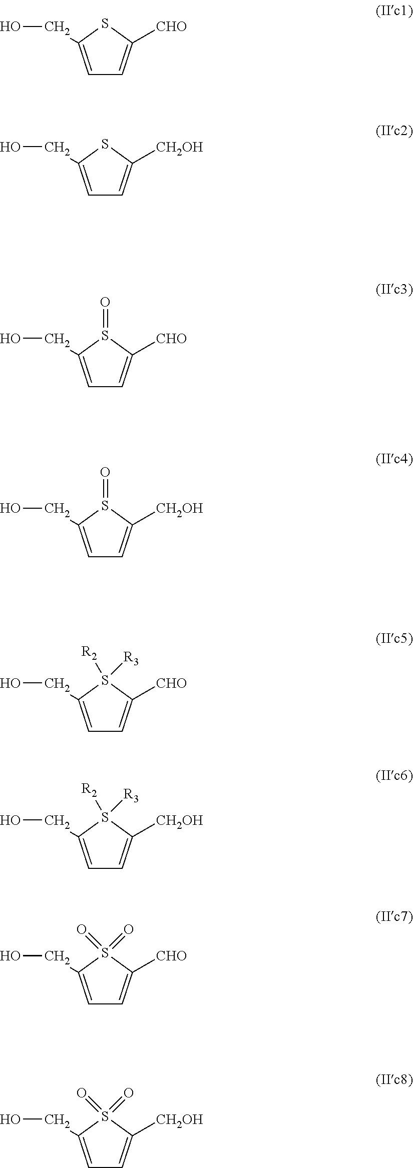

Advantageously, R₂ and R₃ each represent, independently of one another, a C₁-C₆ alkyl radical.

The compound is advantageously of formula (II′c1) or (II′c2).

In another variant, the aromatic ring is a 6-membered ring, possibly comprising 0, one or more heteroatoms, in particular nitrogen, optionally oxidized in N-oxide form. In one variant, the aromatic ring comprises 0, 1 or 2 heteroatom(s).

The B and hydroxymethyl functions are advantageously in the meta or para position relative to one another.

The aromatic ring may bear 0, 1 or 2 aldehyde functions, advantageously 0 or 1 aldehyde function.

The aromatic ring may bear 1, 2 or 3 hydroxymethyl functions, advantageously 1 or 2 hydroxymethyl functions.

In addition, the aromatic ring may also bear 0, 1 or 2 other function(s), in particular hydroxyl.

Advantageously, the compound is of general formula (III):

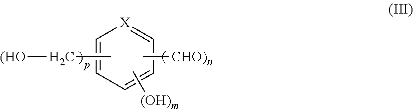

in which X represents C or NR₁, n is 0, 1 or 2, m is 0 or 1, p is 1, 2 or 3. R₁ represents a hydrogen, an alkyl, aryl, arylalkyl, alkylaryl or cycloalkyl group. In accordance with the invention, p+n>1 with p>0.

Advantageously, R₁ represents a hydrogen or a C₁-C₆ alkyl group.

In one variant, n is 1, m is 0 and p is 1.

In another variant, n is 1, m is 1 and p is 1.

In another variant, n is 2, m is 1 and p is 1.

In another variant, n is 1, m is 1 and p is 2.

In another variant, n is 0, m is 0 and p is 2.

In another variant, n is 0, m is 1 and p is 2.

In another variant, n is 1, m is 1 and p is 2.

In another variant, n is 0, m is 1 and p is 3.

Preferentially, the aromatic ring of the aldehyde is a benzene ring. More preferentially, this aldehyde is selected from the group consisting of 2-hydroxymethylbenzene-1-carboxaldehyde, 3-hydroxymethylbenzene-1-carboxaldehyde, 4-hydroxymethylbenzene-1-carboxaldehyde, 3-hydroxymethyl-6-hydroxybenzene-1-carboxaldehyde, 3-hydroxymethyl-4-hydroxybenzene-1-carboxaldehyde, 3-hydroxymethyl-2-hydroxybenzene-1-carboxaldehyde, 3-hydroxymethyl-2-hydroxybenzene-1,5-dicarboxaldehyde, 5-hydroxymethyl-2-hydroxybenzene-1,3-dicarboxaldehyde, 3,5-hydroxymethyl-4-hydroxybenzene-1-carboxaldehyde, 3,5-hydroxymethyl-2-hydroxybenzene-1-carboxaldehyde, 1,2-hydroxymethylbenzene, 1,3-hydroxymethylbenzene, 1,4-hydroxymethylbenzene, 1,3-hydroxymethyl-6-hydroxybenzene, 1,3-hydroxymethyl-4-hydroxybenzene, 1,3-hydroxymethyl-2-hydroxybenzene, 1,3,5-hydroxymethyl-2-hydroxybenzene, 1,3-hydroxymethyl-6-hydroxybenzene, 1,3,5-hydroxymethyl-4-hydroxybenzene, 1,3,2-hydroxymethyl-2-hydroxybenzene and the mixtures of these compounds.

Even more preferentially, the aromatic compound used is 1-hydroxymethylbenzene-4-carboxaldehyde of formula (IIIa) or 1,4-hydroxymethylbenzene of formula (IIIb):

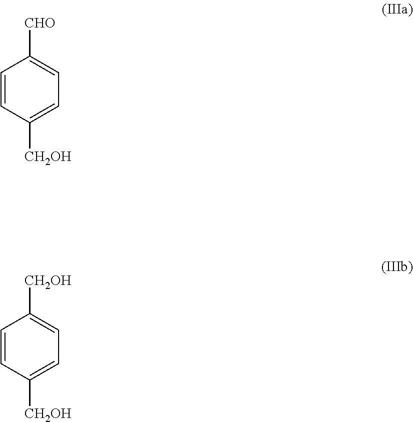 [SMILES: O=Cc1ccc(CO)cc1 ; OCc1ccc(CO)cc1]

Preferably, when the thermosetting resin is based on polyphenol and on one or more compounds of formula (I), the composition is devoid of formaldehyde.

When the thermosetting resin is based on polyphenol, on one or more compounds of formula (I) and on aldehydes, each aldehyde is preferentially other than formaldehyde. The composition is then also devoid of formaldehyde.

In other words and preferably, when an aldehyde is present, the or each aldehyde of the thermosetting resin is other than formaldehyde.

Devoid of formaldehyde is intended to mean that the content by weight of formaldehyde by total weight of the aldehyde(s) is less than or equal to 10%, preferably to 5% and more preferentially to 2%, these percentages corresponding to traces liable to be present in the aldehyde(s) used industrially.

I.2—Aromatic Polyphenol and/or Aromatic Monophenol—Compounds A2 and/or A2′

In one embodiment, the second essential constituent of the thermosetting resin is an aromatic polyphenol A2 comprising one or more aromatic ring(s). The aromatic polyphenol comprises at least one aromatic ring bearing at least two hydroxyl functions in the meta position relative to one another, the two positions ortho to at least one of the hydroxyl functions being unsubstituted.

In another embodiment, the second essential constituent of the thermosetting resin is an aromatic monophenol A2′ comprising at least one six-membered aromatic ring bearing a single hydroxyl function. On this aromatic monophenol, the two positions ortho to the hydroxyl function are unsubstituted, or else at least one position ortho to and the position para to the hydroxyl function are unsubstituted.

In yet another embodiment, the second essential constituent is a mixture of the aromatic polyphenol A2 and the aromatic monophenol A2′ as described above.

In accordance with the invention, the compound A2) may be, in one embodiment, a simple aromatic polyphenol molecule comprising one or more aromatic rings, at least one of these aromatic rings, or even each aromatic ring, bearing at least two hydroxyl functions in the meta position relative to one another, the two positions ortho to at least one of the hydroxyl functions being unsubstituted.

Similarly, the compound A2′) may be, in one embodiment, a simple aromatic monophenol molecule comprising one or more six-membered aromatic rings, at least one of these six-membered aromatic rings, or even each six-membered aromatic ring, bearing a single hydroxyl function, the two positions ortho to the hydroxyl function are unsubstituted, or else at least one position ortho to and the position para to the hydroxyl function are unsubstituted.

Such simple molecules do not comprise a repeat unit.

In accordance with the invention, the compound A2) may be, in another embodiment, a pre-condensed resin based:
on at least one aromatic polyphenol comprising at least one aromatic ring bearing at least two hydroxyl functions in the meta position relative to one another, the two positions ortho to at least one of the hydroxyl functions being unsubstituted; and
on at least one compound capable of reacting with said aromatic polyphenol comprising at least one aldehyde function and/or at least one compound capable of reacting with said aromatic polyphenol comprising at least two hydroxymethyl functions borne by an aromatic ring.

Such a pre-condensed resin based on aromatic polyphenol is in accordance with the invention and comprises, unlike the simple molecule described above, a repeat unit. In this instance, the repeat unit comprises at least one aromatic ring bearing at least two hydroxyl functions in the meta position relative to one another.

Similarly and in accordance with the invention, the compound A2′) may be, in another embodiment, a pre-condensed resin based on:
at least one aromatic monophenol comprising at least one six-membered aromatic ring bearing a single hydroxyl function:
   the two positions ortho to the hydroxyl function being unsubstituted, or
   at least one position ortho to and the position para to the hydroxyl function being unsubstituted;
at least one compound capable of reacting with said aromatic monophenol comprising at least one aldehyde function and/or at least one compound capable of reacting with said aromatic monophenol comprising at least two hydroxymethyl functions borne by an aromatic ring.

Such a pre-condensed resin based on aromatic monophenol is in accordance with the invention and comprises, unlike the simple molecule described above, a repeat unit. In this instance, the repeat unit comprises at least one six-membered aromatic ring bearing a single hydroxyl function.

In another embodiment, the compound A2) and/or A2′) is a mixture of an aromatic polyphenol that forms a simple molecule and of a pre-condensed resin based on aromatic polyphenol.

In the following particular embodiments, the aromatic ring(s) of the aromatic polyphenol and/or of the aromatic monophenol are described. For the sake of clarity, the “aromatic polyphenol” and/or the “aromatic monophenol” is described therein in its simple molecule form. This aromatic polyphenol and/or this aromatic monophenol will then be able to be condensed and will in part define the repeat unit. The characteristics of the pre-condensed resin are described in greater detail below.

### Aromatic Polyphenol A2

In a preferred embodiment, the aromatic ring of the aromatic polyphenol bears three hydroxyl functions in the meta position relative to one another.

The two positions ortho to each hydroxyl function are preferably unsubstituted. This is intended to mean that the two carbon atoms located on either side of (in the position ortho to) the hydroxylated carbon atom (i.e. that which bears the hydroxyl function) just bear a hydrogen atom.

Even more preferentially, the remainder of the aromatic ring is unsubstituted. This is intended to mean that the other carbon atoms of the remainder of the aromatic ring (those other than the carbon atoms bearing hydroxyl functions) just bear a hydrogen atom.

In one embodiment, the aromatic polyphenol comprises several aromatic rings, at least two of these each bearing at least two hydroxyl functions in the meta position relative to one another, the two positions ortho to at least one of the hydroxyl functions of at least one aromatic ring being unsubstituted.

In a preferred embodiment, at least one of the aromatic rings of the aromatic polyphenol bears three hydroxyl functions in the meta position relative to one another.

The two positions ortho to each hydroxyl function of at least one aromatic ring are preferably unsubstituted.

Even more preferentially, the two positions ortho to each hydroxyl function of each aromatic ring are unsubstituted.

Even more preferentially, the remainder of each of the aromatic rings is unsubstituted. This is intended to mean that the other carbon atoms of the remainder of each aromatic ring (those other than the carbon atoms bearing hydroxyl functions or bearing groups that attach the aromatic rings to one another) just bear a hydrogen atom.

Advantageously, the aromatic ring bearing at least two hydroxyl functions in the meta position relative to one another, the two positions ortho to at least one of the hydroxyl functions being unsubstituted, is a benzene ring.

Advantageously, each aromatic ring of the aromatic polyphenol is a benzene ring.

Mention may in particular be made, as example of aromatic polyphenol comprising just one aromatic ring, of resorcinol and phloroglucinol, as a reminder of expanded formulae (IV) and (V), respectively:

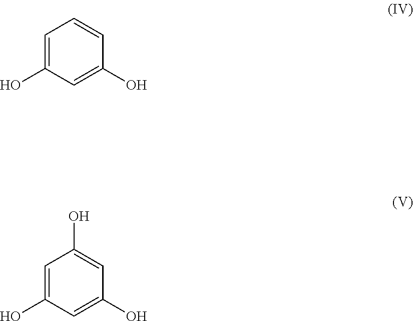 [SMILES: Oc1cccc(O)c1 ; Oc1cc(O)cc(O)c1]

By way of examples, in the case in which the aromatic polyphenol comprises several aromatic rings, at least two of these aromatic rings, which are identical or different, are selected from those of general formulae:

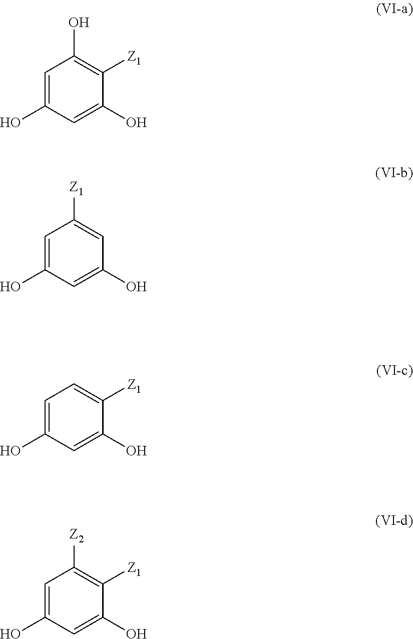

in which the Z₁ and Z₂ symbols, which are identical or different, if there are several of them on the same aromatic ring, represent an atom (for example, carbon, sulfur or oxygen) or a connecting group, by definition at least divalent, which connects at least these two aromatic rings to the remainder of the aromatic polyphenol.

Another example of aromatic polyphenol is 2,2′,4,4′-tetrahydroxydiphenyl sulfide of the following expanded formula (VII):

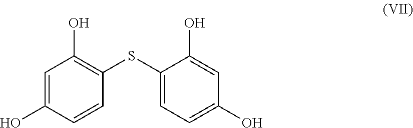 [SMILES: Oc1ccc(Sc2ccc(O)cc2O)c(O)c1]

Another example of aromatic polyphenol is 2,2′,4,4′-tetrahydroxydiphenyl benzophenone of the following expanded formula (VIII):

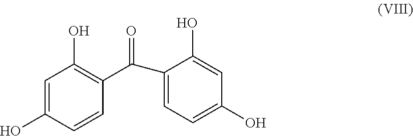 [SMILES: O=C(c1ccc(O)cc1O)c1ccc(O)cc1O]

It is noted that each compound VII and VIII is an aromatic polyphenol comprising two aromatic rings (of formulae VI-c), each of which bears at least two (in this instance two) hydroxyl functions in the meta position relative to one another.

It is noted, in the case of an aromatic polyphenol comprising at least one aromatic ring in accordance with formula VI-b, that the two positions ortho to each hydroxyl function of at least one aromatic ring are unsubstituted. In the case of an aromatic polyphenol comprising several aromatic rings in accordance with formula VI-b, the two positions ortho to each hydroxyl function of each aromatic ring are unsubstituted.

According to one embodiment of the invention, the aromatic polyphenol is selected from the group consisting of resorcinol (IV), phloroglucinol (V), 2,2′,4,4′-tetrahydroxydiphenyl sulfide (VII), 2,2′,4,4′-tetrahydroxybenzophenone (VIII) and the mixtures of these compounds. In a particularly advantageous embodiment, the aromatic polyphenol is phloroglucinol.

In one embodiment, the compound A2) comprises a pre-condensed resin based on the aromatic polyphenol as described in any one of these embodiments.

This pre-condensed resin is advantageously based:
on at least one aromatic polyphenol as defined above, and preferentially selected from the group consisting of resorcinol (IV), phloroglucinol (V), 2,2′,4,4′-tetrahydroxydiphenyl sulfide (VII), 2,2′,4,4′-tetrahydroxybenzophenone (VIII) and the mixtures thereof; and
on at least one compound capable of reacting with said aromatic polyphenol comprising at least one aldehyde function and/or at least one compound capable of reacting with said aromatic polyphenol comprising at least two hydroxymethyl functions borne by an aromatic ring.

The compound capable of reacting with said aromatic polyphenol may be an aromatic compound as defined above in paragraph I.1, a compound of formula Ar—(CHO)₂, in which Ar is as defined above for the aromatic compound of paragraph I.1, or any other aldehyde. Advantageously, said compound is selected from the group consisting of an aromatic compound comprising an aromatic ring bearing at least two functions, one of these functions being a hydroxymethyl function, the other being an aldehyde function or a hydroxymethyl function, formaldehyde, furfuraldehyde, 2,5-furandicarboxaldehyde, 1,4-benzenedicarboxaldehyde, 1,3-benzenedicarboxaldehyde, 1,2-benzenedicarboxaldehyde and mixtures of these compounds. Very advantageously, when the compound is an aromatic compound comprising an aromatic ring bearing at least two functions, one of these functions being a hydroxymethyl function, the other being an aldehyde function or a hydroxymethyl function, this compound is selected from the group consisting of 5-(hydroxymethyl)furfural, 2,5-di(hydroxymethyl)furan and mixtures of these compounds.

Thus, in the pre-condensed resin based on aromatic polyphenol, the repeat unit corresponds to the characteristics of the aromatic polyphenol defined above except that at least one of the carbon atoms of the aromatic ring, which was unsubstituted, is connected to another unit.

Irrespective of the compound other than the aromatic polyphenol at the heart of the pre-condensed resin, this pre-condensed resin is devoid of free formaldehyde. Indeed, even in the case in which the pre-condensed resin is based on an aromatic polyphenol as described previously and on formaldehyde, since the formaldehyde has already reacted with the aromatic polyphenol, the pre-condensed resin is devoid of free formaldehyde liable to be able to react with a compound A1 in accordance with the invention in a subsequent step.

The compound A2) may also comprise a mixture of a free aromatic polyphenol molecule and of a pre-condensed resin based on aromatic polyphenol, as described above. In particular, the compound A2) may also comprise a mixture of phloroglucinol and of a pre-condensed resin based on phloroglucinol.

### Aromatic Monophenol A2′

The monophenol A2′ may be in accordance with two variants. In one variant, the two positions ortho to the hydroxyl function are unsubstituted. In another variant, at least one position ortho to and the position para to the hydroxyl function are unsubstituted.

Advantageously, in the variant in which at least one position ortho to and the position para to the hydroxyl function are unsubstituted, a single ortho position is unsubstituted and the position para to the hydroxyl function is unsubstituted.

Preferably, regardless of the variant, the two positions ortho to the hydroxyl function are unsubstituted. This is intended to mean that the two carbon atoms located on either side of (in the position ortho to) the hydroxylated carbon atom (i.e. that which bears the hydroxyl function) just bear a hydrogen atom.

Even more preferentially, the remainder of the aromatic ring is unsubstituted. This is intended to mean that the other carbon atoms of the remainder of the aromatic ring (those other than the carbon atoms bearing hydroxyl functions) just bear a hydrogen atom.

In one embodiment, the aromatic monophenol comprises several six-membered aromatic rings, at least two of which each bear a single hydroxyl function and, for at least one of the hydroxyl functions, the two positions ortho to the hydroxyl function are unsubstituted, or at least one position ortho to and the position para to the hydroxyl function are unsubstituted.

Preferably, the two positions ortho to each hydroxyl function of at least one six-membered aromatic ring are unsubstituted.

Even more preferentially, the two positions ortho to each hydroxyl function of each six-membered aromatic ring are unsubstituted.

Even more preferentially, the remainder of each of the aromatic rings is unsubstituted. This is intended to mean that the other carbon atoms of the remainder of each aromatic ring (those other than the carbon atoms bearing hydroxyl functions or bearing groups that attach the aromatic rings to one another) just bear a hydrogen atom.

Advantageously, the, or each, aromatic ring of the aromatic monophenol is a benzene ring.

Preferably, the aromatic monophenol is selected from the group consisting of phenol, ortho-cresol, meta-cresol, para-cresol, ortho-chlorophenol, meta-chlorophenol, para-chlorophenol, 2-hydroxybenzoic acid, 3-hydroxybenzoic acid, 4-hydroxybenzoic acid, 4-vinylphenol, 4-ethylphenol, 4-isopropylphenol, 4-isobutylphenol, para-coumaric acid, and mixtures of these compounds.

In one embodiment, the compound A2′) comprises a pre-condensed resin based on the aromatic monophenol as described in any one of these embodiments.

This pre-condensed resin is advantageously based:
on at least one aromatic monophenol as defined above, and preferentially selected from the group consisting of phenol, ortho-cresol, meta-cresol, para-cresol, ortho-chlorophenol, meta-chlorophenol, para-chlorophenol, 2-hydroxybenzoic acid, 3-hydroxybenzoic acid, 4-hydroxybenzoic acid, 4-vinylphenol, 4-ethylphenol, 4-isopropylphenol, 4-isobutylphenol, para-coumaric acid, and mixtures of these compounds; and
on at least one compound capable of reacting with said aromatic monophenol comprising at least one aldehyde function and/or at least one compound capable of reacting with said aromatic monophenol comprising at least two hydroxymethyl functions borne by an aromatic ring.

The compound capable of reacting with said aromatic monophenol may be an aromatic compound as defined above in paragraph I.1, a compound of formula Ar—(CHO)₂, in which Ar is as defined above for the aromatic compound of paragraph I.1, or any other aldehyde. Advantageously, said compound is selected from the group consisting of an aromatic compound comprising an aromatic ring bearing at least two functions, one of these functions being a hydroxymethyl function, the other being an aldehyde function or a hydroxymethyl function, formaldehyde, furfuraldehyde, 2,5-furandicarboxaldehyde, 1,4-benzenedicarboxaldehyde, 1,3-benzenedicarboxaldehyde, 1,2-benzenedicarboxaldehyde and mixtures of these compounds. Very advantageously, when the compound is an aromatic compound comprising an aromatic ring bearing at least two functions, one of these functions being a hydroxymethyl function, the other being an aldehyde function or a hydroxymethyl function, this compound is selected from the group consisting of 5-(hydroxymethyl)furfural, 2,5-di(hydroxymethyl)furan and mixtures of these compounds.

Thus, in the pre-condensed resin based on aromatic monophenol, the repeat unit corresponds to the characteristics of the aromatic monophenol defined above except that at least one of the carbon atoms of the six-membered aromatic ring, which was unsubstituted, is connected to another unit.

Irrespective of the compound other than the aromatic monophenol at the heart of the pre-condensed resin, this pre-condensed resin is devoid of free formaldehyde. Indeed, even in the case in which the pre-condensed resin is based on an aromatic monophenol as described previously and on formaldehyde, since the formaldehyde has already reacted with the aromatic monophenol, the pre-condensed resin is devoid of free formaldehyde liable to be able to react with a compound A1 in accordance with the invention in a subsequent step.

The compound A2′) may also comprise a mixture of a free aromatic monophenol molecule and of a pre-condensed resin based on aromatic monophenol, as described above. In particular, the compound A2′) may also comprise a mixture of phenol and of a pre-condensed resin based on phenol.

### I.3—Unsaturated Elastomer Latex

It is recalled that a latex is a stable dispersion of microparticles of elastomer(s) in suspension in a generally aqueous solution. An elastomer latex is therefore a composition in a liquid state comprising a liquid solvent, generally water, and at least one elastomer or a rubber dispersed in the liquid solvent so as to form an emulsion. Thus, the latex is not a rubber composition which comprises a matrix of elastomer or of rubber in which at least one other component is dispersed. A rubber composition is in a plastic state in the uncured (non-crosslinked) state and in an elastic state in the cured (crosslinked) state, but never in a liquid state, unlike a latex.

Unsaturated (that is to say, bearing carbon-carbon double bonds) elastomer latices, especially diene elastomer latices, are well known to those skilled in the art. They especially form the elastomeric base of the RFL adhesives described in the introduction to the present document.

In accordance with the invention, the unsaturated elastomer of the latex is preferentially a diene elastomer, more preferentially a diene elastomer selected from the group consisting of polybutadienes, butadiene copolymers, polyisoprenes, isoprene copolymers and the mixtures of these elastomers. It is more preferentially still selected from the group consisting of butadiene copolymers, vinylpyridine/styrene/butadiene terpolymers, natural rubber and the mixtures of these elastomers.

### I.4—Aqueous Adhesive Solution Comprising a Pre-Condensed Resin of the Invention

Another subject of the invention is an aqueous adhesive solution comprising a pre-condensed resin based on:
A1) at least one aromatic compound bearing at least two functions, one of these functions being a hydroxymethyl function and the other being an aldehyde function or a hydroxymethyl function, the aromatic compound comprising at least one aromatic ring; and
A2) at least one aromatic polyphenol comprising at least one aromatic ring bearing at least two hydroxyl functions in the meta position relative to one another, the two positions ortho to at least one of the hydroxyl functions being unsubstituted.

Advantageously, the pre-condensed resin is also based on:
A2′) at least one aromatic monophenol comprising at least one six-membered aromatic ring bearing a single hydroxyl function,
   the two positions ortho to the hydroxyl function being unsubstituted, or
   at least one position ortho to and the position para to the hydroxyl function being unsubstituted.

The aromatic compound is as described above; in particular it is a compound of formula (I) as defined above.

The aromatic polyphenol and/or the aromatic monophenol is as described above; in particular, it is preferentially an aromatic polyphenol and/or an aromatic monophenol which is a single molecule.

N1 is defined as the number of reactive sites on the aromatic compound, as follows: an aldehyde function represents two reactive sites and a hydroxymethyl function represents one reactive site. Thus, for example, 5-(hydroxymethyl)furfural has N1=3 reactive sites and 2,5-di(hydroxymethyl)furan has N1=2 reactive sites.

In the case of an aromatic polyphenol, N2 is defined as the number of reactive sites of the aromatic polyphenol, as follows: each free carbon on the aromatic ring adjacent to a hydroxyl function borne by the aromatic ring represents a reactive site, each free carbon only being able to be counted as a reactive site for a single adjacent hydroxyl function. Thus, for example, resorcinol and phloroglucinol each have N2=3 reactive sites and 2,2′,4,4′-tetrahydroxydiphenyl sulfide has N2=4 reactive sites.

In the case of an aromatic monophenol, N′2 is defined as the number of reactive sites of the aromatic monophenol, as follows: each free carbon on the six-membered aromatic ring adjacent to the hydroxyl function borne by the aromatic ring represents a reactive site, and the free carbon of the six-membered aromatic ring positioned para to the hydroxyl function represents a reactive site. Thus, for example, phenol has N′2=3 reactive sites.

The pre-condensed resin is obtained by mixing:
the aromatic compound A1), and
the aromatic polyphenol A2), and optionally
the aromatic monophenol A2′),
   in a basic solvent preferably having a pH of between 8 and 13, more preferentially between 9 and 12, or in an acidic or neutral solvent preferably having a pH of between 4 and 7 and more preferentially between 5 and 7.

The pre-condensed resin is advantageously prepared by gradually mixing the aromatic polyphenol and optionally the aromatic monophenol and the aromatic compound A1 in an aqueous solution.

In a first variant, the components on which the pre-condensed resin is based are mixed in a basic solvent, such as an aqueous sodium hydroxide solution, preferably having a pH of between 8 and 13, more preferentially between 9 and 12.

In a second variant, the components on which the pre-condensed resin is based are mixed in an acidic or neutral solvent such as an aqueous solution having a pH of between 4 and 7, preferably between 5 and 7.

In some cases, for example at relatively high concentrations or in the case of an acidic solvent, those skilled in the art may find cause to add a thickener, for example carboxymethyl cellulose, or a gelling agent, for example a gelatin, in order to limit sedimentation of the pre-condensed resin.

Regardless of the variant, the combined constituents are mixed with stirring for a time which may vary depending on the temperature used and the specific composition targeted, for example for a period of time which may vary between 1 min and 6 h, at a temperature of between 20° C. and 90° C., preferentially between 20° C. and 60° C.

In the first variant, an acid is advantageously subsequently added so as to neutralize the base and to obtain a pre-condensed resin that can be stored and used subsequently.

In the second variant, a base is advantageously subsequently added so as to neutralize the acid and to obtain a pre-condensed resin that can be stored and used subsequently.

In order to prepare the pre-condensed resin, the molar amount n2 of aromatic polyphenol A2, the molar amount n′2 of aromatic monophenol A2′ and the molar amount n1 of the aromatic compound A1 are such that [(n2*N2)+(n′2N′2)]/(n1*N1)>1, preferably 1<[(n2*N2)+)+(n′2N′2)]/(n1*N1)<5.

The pre-condensed resin is subsequently generally diluted in water.

In the final aqueous adhesive solution thus prepared, the solids content of pre-condensed resin according to the invention preferably represents between 2 and 30% by weight, more preferentially between 5 and 15% by weight.

The water content of the final aqueous adhesive solution thus prepared is preferably between 70 and 98% by weight, more preferentially between 85 and 95% by weight.

“Water content of the aqueous adhesive solution” is intended to mean the weight of water relative to the total weight of the adhesive solution.

### I.5—Additives—Manufacture of the Aqueous Adhesive Composition

The aqueous adhesive composition in accordance with the invention may of course comprise all or some of the additives customary for aqueous adhesive compositions, such as those used in conventional RFL adhesives; mention will be made, for example, of bases such as aqueous ammonia, sodium, potassium or ammonium hydroxide, dyes, fillers such as carbon black or silica, antioxidants or other stabilizers, and thickeners, for example carboxymethyl cellulose, or gelling agents, for example a gelatin, making it possible to increase the viscosity of the composition. Mention will also be made of additives that make it possible to modify the setting or gelling time and the open time of the resin. As is known to those skilled in the art, the setting or gelling time is the length of time for which it is possible to apply the resin to its substrate and the open time is the length of time for which, after application of the resin to its substrate, it is possible to leave the resin in the open air without adversely affecting the quality of the subsequent adhesive bond with the complementary substrate. The setting time or gelling time and the open time are especially dependent on the temperature, pressure or else the resin concentration.

Typically, during a first resinification step, the constituents of the thermosetting resin itself are mixed, advantageously in water.

This first resinification step may be carried out according to several embodiments.

Before describing in detail the different embodiments, it will firstly be specified that the thermosetting resin of the aqueous adhesive composition may be obtained by mixing the constituents of the resin, that is to say said aromatic compound A1) as defined above, said aromatic compound A2) as defined above and/or said aromatic compound A2′) as defined above, in a solvent that is either basic, preferably having a pH of between 8 and 13, more preferentially between 9 and 12, or acidic or neutral, preferably having a pH of between 4 and 7, more preferentially between 5 and 7. This solvent is advantageously water that has been rendered basic by addition of a base or rendered acidic by addition of an acid.

In a first embodiment, use is made of a pre-condensed resin based on aromatic polyphenol as defined in paragraph I.2, that is to say that which results based:
on at least one aromatic polyphenol comprising at least one aromatic ring bearing at least two hydroxyl functions in the meta position relative to one another, the two positions ortho to at least one of the hydroxyl functions being unsubstituted; and
on at least one compound capable of reacting with said aromatic polyphenol comprising at least one aldehyde function and/or at least one compound capable of reacting with said aromatic polyphenol comprising at least two hydroxymethyl functions borne by an aromatic ring.

The pre-condensed resin based on aromatic polyphenol A2 is advantageously prepared by gradually mixing the aromatic polyphenol and the compound comprising at least one aldehyde function and/or the compound comprising at least two hydroxymethyl functions borne by an aromatic ring, for example formaldehyde, in molar amounts as described above.

In a first variant, the components on which the pre-condensed resin is based are mixed in a basic solvent, such as an aqueous sodium hydroxide solution, preferably having a pH of between 8 and 13, more preferentially between 9 and 12.

Thus, the pre-condensed resin is obtained by mixing:
said aromatic polyphenol, and
said compound capable of reacting with said aromatic polyphenol,
in a basic solvent preferably having a pH of between 8 and 13 and more preferentially between 9 and 12.

In a second variant, the components on which the pre-condensed resin is based are mixed in an acidic or neutral solvent such as an aqueous solution having a pH of between 4 and 7, preferably between 5 and 7.

Thus, the pre-condensed resin is obtained by mixing:
said aromatic polyphenol, and
said compound capable of reacting with said aromatic polyphenol,
in an acidic or neutral solvent preferably having a pH of between 4 and 7 and more preferentially between 5 and 7.

In some cases, for example at relatively high concentrations or in the case of an acidic solvent, those skilled in the art may find cause to add a thickener, for example carboxymethyl cellulose, or a gelling agent, for example a gelatin, in order to limit sedimentation of the pre-condensed resin.

Regardless of the variant, the combined constituents are mixed with stirring for a time which may vary depending on the temperature used and the specific composition targeted, for example for a period of time which may vary between 1 min and 6 h, at a temperature of between 20° C. and 90° C., preferentially between 20° C. and 60° C.

As described above, it is advantageously possible to neutralize the medium so as to obtain a pre-condensed resin that can be stored and used subsequently.

Then, in this first embodiment, the adhesive composition may be obtained by mixing:
this pre-condensed resin (compound A2), and
the aromatic compound A1,
   in a basic solvent preferably having a pH of between 8 and 13, more preferentially between 9 and 12, or in an acidic or neutral solvent preferably having a pH of between 4 and 7 and more preferentially between 5 and 7.

In particular, this pre-condensed resin based on aromatic polyphenol (compound A2) is mixed gradually with the aromatic compound A1 in a basic solvent such as an aqueous sodium hydroxide solution, preferably having a pH of between 8 and 13, more preferentially between 9 and 12, or else in an acidic or neutral solvent such as an aqueous solution having a pH of between 4 and 7, preferably between 5 and 7. Regardless of whether it is in acidic or basic medium, all the constituents are mixed with stirring for a length of time which may vary depending on the temperature used and the specific composition targeted, for example for a duration which may vary between 1 min and 6 h, at a temperature of between 20° C. and 90° C., preferentially between 20 and 60° C. Those skilled in the art will know how to adjust the molar amounts of the pre-condensed resin based on aromatic polyphenol A2 and on the aromatic compound A1 in order to obtain crosslinking and a concentration suitable for the desired use, especially as a function of the nature of the pre-condensed resin based on aromatic polyphenol A2.

In a second embodiment, use is made of a pre-condensed resin as described in paragraph I-4, that is to say based on:
A1) at least one aromatic compound bearing at least two functions, one of these functions being a hydroxymethyl function and the other being an aldehyde function or a hydroxymethyl function, the aromatic compound comprising at least one aromatic ring, for example 5-(hydroxymethyl)furfural, and
A2) at least one aromatic polyphenol comprising at least one aromatic ring bearing at least two hydroxyl functions in the meta position relative to one another, the two positions ortho to at least one of the hydroxyl functions being unsubstituted, for example phloroglucinol.

In this second embodiment, the pre-condensed resin based on aromatic polyphenol in accordance with the invention is prepared under conditions analogous to the pre-condensed resin based on aromatic polyphenol of the first embodiment. Then, this pre-condensed resin based on aromatic polyphenol according to the invention A2 is gradually mixed with the aromatic compound A1 under conditions analogous to those of the first embodiment. Here too, those skilled in the art will know how to adjust the molar amounts of pre-condensed resin based on aromatic polyphenol A2 and on the aromatic compound A1 in order to obtain crosslinking and a concentration suitable for the desired use, especially as a function of the nature of the pre-condensed resin based on aromatic polyphenol A2.

In a third embodiment, use is made of an aromatic polyphenol A2 according to the invention in the form of a single molecule, for example phloroglucinol.

In a first variant, the thermosetting resin is obtained by:
mixing the aromatic polyphenol A2) in the form of a single molecule in a basic solvent preferably having a pH of between 8 and 13, more preferentially between 9 and 12 or in an acidic or neutral solvent preferably having a pH of between 4 and 7, more preferentially between 5 and 7,
then addition of the aromatic compound A1).

In particular, the aromatic polyphenol A2 is firstly mixed in a basic solvent such as an aqueous sodium hydroxide solution, preferably having a pH of between 8 and 13, more preferentially between 9 and 12, or else in an acidic or neutral solvent such as an aqueous solution having a pH of between 4 and 7, preferably between 5 and 7.

In some cases, for example at relatively high concentrations or in the case of an acidic solvent, those skilled in the art may find cause to add a thickener, for example carboxymethyl cellulose, or a gelling agent, for example a gelatin, in order to limit sedimentation of the aromatic polyphenol A2.

Then, the aromatic compound A1) is added. In particular, the aromatic compound A1 is gradually added under conditions analogous to those of the first embodiment.

In a second variant, the thermosetting resin is obtained by:
mixing the aromatic compound A1) in a basic solvent preferably having a pH of between 8 and 13, more preferentially between 9 and 12, or in an acidic or neutral solvent preferably having a pH of between 4 and 7 and more preferentially between 5 and 7,
then adding the aromatic polyphenol A2) in the form of a single molecule.

In particular, the aromatic compound A1 is firstly mixed in an aqueous solution, preferably in a basic solvent, such as an aqueous sodium hydroxide solution, preferably having a pH of between 8 and 13, more preferentially between 9 and 12. Then, the aromatic polyphenol A2 is added and the components are mixed under conditions analogous to those of the first embodiment.

A molar amount n2 of aromatic polyphenol A2 and a molar amount n1 of the aromatic compound A1 are mixed such that 0.3≤(n2*N2)/(n1*N1)≤3, and preferably 1<(n2*N2)/(n1*N1)≤2.

In each of the three preceding embodiments, the aromatic polyphenol could be entirely or partially replaced by an aromatic monophenol comprising at least one six-membered aromatic ring bearing a single hydroxyl function, the two positions ortho to the hydroxyl function being unsubstituted, or at least one position ortho to and the position para to the hydroxyl function being unsubstituted.

In this case, in the third embodiment described above, in which use is made of compounds in the form of single molecules, a molar amount n2 of aromatic polyphenol A2 and/or a molar amount n′2 of aromatic monophenol A2′ and a molar amount n1 of the aromatic compound A1 would then be mixed such that 0.3≤[(n2*N2)+(n′2*N′2)]/(n1*N1)≤3, and preferably 1<[(n2*N2)+(n′2*N′2)]/(n1*N1)≤2.

In any one of these three embodiments, the partially crosslinked thermosetting resin is generally diluted in water before being added to the unsaturated elastomer latex or latices (if there are several), in order to form the aqueous adhesive composition of the invention, according to a general procedure which is well known to those skilled in the art in the field of RFL adhesives.

Preferably, during this step of forming the aqueous adhesive composition, it will be ensured that the aqueous adhesive composition has a pH of between 8 and 13, more preferentially between 9 and 12, so as to limit any potential precipitation of the, or of some, unsaturated elastomer latex (latices).

Thus, in the event that, during the resinification step preceding this step of forming the aqueous adhesive composition, use was made of an acidic or neutral solvent or a basic solvent which was neutralised, a base will be added that makes it possible to obtain a pH of between 8 and 13, more preferentially between 9 and 12, prior to the addition of the unsaturated elastomer latex (latices), so as to limit any potential precipitation of the, or of some, unsaturated elastomer latex (latices).

For example, the constituents of the adhesive composition are added in the following order: the water, possible water-soluble additives (for example aqueous ammonia), the latex or latices (any order) and the partially crosslinked thermosetting resin (diluted). The combination is mixed with stirring for 1 to 30 min, for example at 20° C.

During a final manufacturing step, referred to as maturation step, the aqueous adhesive composition is generally stored at ambient temperature (23° C.) for a maturation time which can typically vary from 1 to several hours, indeed even several days, before it is finally used.

The final adhesive composition thus prepared has a total solids content, advantageously a solids content of thermosetting resin and of latex, between 5 and 60%, more preferentially between 10 and 40% by weight.

In a first embodiment, the total solids content, advantageously the solids content of thermosetting resin and of latex, is more preferentially between 10 and 30% by weight.

In a second embodiment, the total solids content, advantageously the solids content of thermosetting resin and of latex, is more preferentially between 15 and 40% by weight.

“Total solids content of the adhesive composition” is intended to mean the ratio of the weight of residue obtained after drying the aqueous adhesive composition to the weight of aqueous adhesive composition before drying.

“Solids content of the thermosetting resin and of latex” is intended to mean the ratio of the weight of thermosetting resin and of latex obtained after drying the aqueous adhesive composition to the weight of aqueous adhesive composition before drying.

These two solids contents are measured in accordance with standard NF EN 827 (March 2006).

The content of unsaturated elastomer (that is to say, the solids of the latex or latices) is preferably between 40 and 95%, more preferentially between 70 and 90% by weight of the solids of the adhesive composition.

The weight ratio of resin solids to latex solids is preferably between 0.1 and 2.0, more preferentially between 0.15 and 1.0.

The water content of the aqueous adhesive composition of the invention is preferably between 60 and 90% by weight, more preferentially between 60 and 85% by weight.

“Water content of the aqueous adhesive composition” is intended to mean the weight of water relative to the total weight of the adhesive composition.

### II—Textile Material and Composite of the Invention

As indicated above, the present invention also relates to the use of the aqueous adhesive composition described above for the adhesive bonding of any textile material to an unsaturated rubber composition, for formation of a reinforced rubber composite of such a material, and also, as such, to the textile material, at least a portion of which is coated with an adhesive composition according to the invention.

### II.1—Definitions; Examples of Textile Materials

In the present patent application, by definition, “textile” or “textile material” is intended to mean, as is well known to those skilled in the art, any material made of a substance other than a metallic substance, whether natural or synthetic, which is capable of being transformed into thread, fibre or film by any appropriate transformation process. Mention may be made, for example, without the examples below being limiting, of a polymer spinning process, such as, for example, melt spinning, solution spinning or gel spinning.

This textile material may consist of a thread or fibre, a ribbon or film, or also of a fabric produced from threads or fibres, for example a woven fabric with warp threads and weft threads, or else a twill fabric with cross threads.

Preferably, this textile material of the invention is selected from the group consisting of films, monofilaments (or individual threads), multifilament fibres, assemblies of such threads or fibres, and assemblies of such materials. It is more particularly a monofilament, a multifilament fibre or a folded yarn.

The term “thread” or “fibre” is generally intended to mean any elongate element of great length relative to its cross section, regardless of the shape, for example circular, oblong, rectangular, square, or even flat, of this cross section, it being possible for this thread to be straight or not straight, for example twisted or wavy. The largest dimension of its cross section is preferentially less than 5 mm, more preferentially less than 3 mm.

This thread or fibre may take any known form. For example, it may be an individual monofilament of large diameter (for example and preferably equal to or greater than 50 μm), a multifilament fibre (consisting of a plurality of individual filaments of small diameter, typically less than 30 μm), a textile folded yarn or cord formed from several textile fibres or monofilaments twisted or cabled together, or else an assembly, group or row of threads or fibres, such as, for example, a band or strip comprising several of these monofilaments, fibres, folded yarns or cords grouped together, for example aligned along a main direction, whether straight or not.

The term “film” or “ribbon” is generally understood to mean an elongate element of great length relative to its cross section, the cross section of which has an aspect ratio (width to thickness) of greater than 5, preferably of greater than 10, and the width of which is preferentially at least equal to 3 mm, more preferentially at least equal to 5 mm.

The aqueous adhesive composition of the invention can be applied to any textile material as described above and capable of reinforcing rubber articles, such as tyres, including textile materials made of organic or polymeric substance, such as made of inorganic substance.

Mention will be made, as examples of inorganic substances, of glass or carbon.

The invention is preferentially implemented with materials made of polymeric substance, of both the thermoplastic and non-thermoplastic type.

Mention will be made, as examples of polymeric substances of the non-thermoplastic type, for example, of aramid (aromatic polyamide) and cellulose, both natural and artificial, such as cotton, rayon, flax or hemp.

Mention will preferably be made, as examples of polymeric substances of the thermoplastic type, of aliphatic polyamides and of polyesters. Mention may especially be made, among the aliphatic polyamides, of the polyamides 4-6, 6, 6-6, 11 or 12. Mention may be made, among the polyesters, for example, of PET (polyethylene terephthalate), PEN (polyethylene naphthalate), PBT (polybutylene terephthalate), PBN (polybutylene naphthalate), PPT (polypropylene terephthalate), PPN (polypropylene naphthalate), PEF (polyethylene furanoate), PBF (polybutylene furanoate), and PPF (polypropylene furanoate).

Preferably, the substance of the textile material is selected from the group consisting of polyesters, polyamides, polyketones, polyvinyl alcohols, celluloses and combinations of these materials.

More preferentially, the substance of the textile material is selected from the group consisting of polyesters, aliphatic polyamides and aromatic polyamides and combinations of these materials.

### II.2—Manufacture of the Textile Material and of the Composite

The coated textile material of the invention may be prepared according to a manufacturing process, generally referred to as sizing process, characterized in that it comprises at least one step of coating the starting (initial) textile material with an adhesive composition in accordance with the invention.

The step of deposition of the adhesive composition on the initial textile material (starting textile material) may be carried out according to any suitable method, especially by any known coating technique, such as, for example, spraying, impregnation by dipping, forward progression in a bath or other equivalent technique for the deposition of a thin or ultra-thin film of adhesive, or also by a combination of one or more of these techniques.

During the impregnation by dipping in a bath or forward progression in a bath, said bath is advantageously at ambient temperature, that is to say from 18° C. to 25° C.

The solids weight of the aqueous adhesive composition deposited on one kilogram of textile material is preferably between 5 and 100 g, more preferentially between 30 and 70 g, more preferentially still between 40 and 60 g.

The invention also applies to the cases in which the starting textile material has been precoated with an adhesion primer, such as those commonly used by those skilled in the art for the pre-sizing of certain textile fibres (e.g., PET or aramid fibres). The fibres, thus precoated, are then subjected to a subsequent and definitive sizing with the aqueous adhesive composition according to the invention.

After the step described above of deposition of the adhesive composition, the sized material is subjected to a first heat treatment, targeted at removing any solvent or water, at a temperature of preferably between 110° C. and 260° C., more preferentially between 130° C. and 250° C., for example by passing through a tunnel oven, typically with a length of several metres, such as those commonly used for heat treatment after sizing of textile materials with an RFL adhesive.

The invention thus relates to the coated textile material obtained after drying, that is to say, after a heat treatment targeted at removing the water from the textile material according to the invention, at least a portion of which is coated with an adhesive layer comprising an adhesive composition according to the invention.

The anhydrous material thus obtained is then subjected to a second heat treatment, during which the anhydrous coated textile material is heated in order to terminate the crosslinking of the thermosetting resin, preferentially carried out in air in a tunnel oven as described above. The treatment temperature is preferably between 150° C. and 350° C. The treatment times are from a few seconds to a few minutes, according to the circumstances (for example, between 10 s and 10 min).

The invention thus relates to the coated textile material obtained after crosslinking of the thermosetting resin, that is to say after a heat treatment aimed at terminating the crosslinking of the thermosetting resin.

Where appropriate, those skilled in the art will know how to adjust the temperature and the duration of the heat treatment above according to the particular operating conditions of the invention, especially according to the exact nature of the textile material manufactured, in particular depending on whether the treatment is on monofilaments, multifilament fibres, folded yarns consisting of several fibres twisted together, or films. In particular, those skilled in the art will have the advantage of scanning the treatment temperatures and times so as to search, by successive approximations, for the operating conditions leading to the best adhesion results, for each particular embodiment of the invention.

Thus sized, the coated textile material of the invention is preferentially intended to adhere to an unsaturated rubber composition, such as a diene rubber, in order to form a reinforced rubber composite which constitutes another subject of the invention.

This rubber composite of the invention can be prepared according to a process comprising at least the following steps:
during a first step, combining at least a portion of the textile material according to the invention with an unsaturated (crosslinkable) rubber composition, in order to form a rubber composite reinforced with the textile material;
then, during a second step, crosslinking the composite thus formed by curing, preferably under pressure.

The invention thus applies to any type of rubber composite capable of being obtained by the process described above, comprising at least a matrix made of crosslinkable rubber composition, especially diene rubber composition, bonded to the textile material via an adhesive interphase based on the adhesive composition according to the invention.

The diene elastomer of the composite is preferentially selected from the group consisting of polybutadienes (BRs), natural rubber (NR), synthetic polyisoprenes (IRs), butadiene/styrene copolymers (SBRs), isoprene/butadiene copolymers (BIRs), isoprene/styrene copolymers (SIRs), butadiene/styrene/isoprene copolymers (SBIRs) and the mixtures of these elastomers. A preferential embodiment consists in using an “isoprene” elastomer, that is to say an isoprene homopolymer or copolymer, in other words a diene elastomer selected from the group consisting of natural rubber (NR), synthetic polyisoprenes (IRs), the various copolymers of isoprene and the mixtures of these elastomers. The isoprene elastomer is preferably natural rubber or a synthetic polyisoprene of the cis-1,4 type.

### II.3—Application on Tyres

The textile material of the invention can advantageously be used to reinforce tyres for all types of vehicles, in particular passenger vehicles or industrial vehicles, such as heavy-duty vehicles.

By way of example, the single appended FIGURE represents very diagrammatically (without observing a specific scale) a radial section of a tyre in accordance with the invention for a vehicle of the passenger type.

This tyre 1 comprises a crown 2 reinforced by a crown reinforcement or belt 6, two sidewalls 3 and two beads 4, each of these beads 4 being reinforced with a bead wire 5. The crown 2 is surmounted by a tread, not represented in this diagrammatic FIGURE. A carcass reinforcement 7 is wound around the two bead wires 5 in each bead 4, the turn-up 8 of this reinforcement 7 being, for example, positioned towards the outside of the tyre 1, which is here represented fitted onto its wheel rim 9. The carcass reinforcement 7 is, in a way known per se, composed of at least one ply reinforced by “radial” cords, for example textile cords, that is to say that these cords are positioned virtually parallel to one another and extend from one bead to the other so as to form an angle of between 80° and 90° with the median circumferential plane (plane perpendicular to the axis of rotation of the tyre which is located halfway between the two beads 4 and passes through the middle of the crown reinforcement 6).

This tyre 1 of the invention has, for example, the essential characteristic that at least a crown reinforcement (6) and/or its carcass reinforcement (7) comprises a textile material according to the invention. According to another possible exemplary embodiment of the invention, it is, for example, the bead wires (5) which might be entirely or partially composed of a textile material according to the invention.

Of course, the invention relates to the objects described above, namely the textile material and the rubber composite, such as tyre, comprising it, both in the uncured state (before curing or vulcanization) and in the cured state (after curing).

### III—Exemplary Embodiments of the Invention and Comparative Tests

These tests demonstrate that the adhesion, to a diene elastomer composition, of textile cords sized with an aqueous adhesive composition according to the invention is equivalent, or even in some cases improved, in comparison with cords sized with a conventional adhesive composition of the RFL type.

These tests also demonstrate that the process for solubilizing the adhesive composition according to the invention in water is also greatly facilitated in comparison with the adhesive compositions described in document WO2013/017421.

Finally, these tests demonstrate that the wettability of the textile cords is equivalent or even improved relative to a conventional adhesive composition of the RFL type and improved relative to the adhesive compositions described in document WO2013/017421.

For this, eight aqueous adhesive compositions were prepared as indicated above, three in accordance with the invention (hereinafter denoted C-1, C-2 and C-3) and five not in accordance with the invention (control composition, hereinafter denoted T-1 to T-5). Their formulations (expressed as percentage by weight) are presented in the appended Table 1. The amounts listed in this table are those of the constituents in the dry state, with respect to a total of 100 parts by weight of aqueous adhesive composition (that is to say, the constituents plus the water).

The adhesive composition T-1 is a control composition, of RFL type, commonly used for the adhesion of polyamide cords to a rubber composition. This adhesive composition is based on resorcinol and formaldehyde.

The adhesive composition T-2 is a control composition, of RFL type, commonly used for the adhesion of polyamide cords to a rubber composition. This adhesive composition is based on a pre-condensed resorcinol-formaldehyde resin and formaldehyde.

The adhesive composition T-3 is a control composition, of phenol-aldehyde type, as described in application WO2013/017421. This adhesive composition is based on phloroglucinol and terephthaldehyde.

The adhesive composition T-4 is a control composition, of phenol-aldehyde type, as described in application WO2013/017421. This adhesive composition is based on a pre-condensed resorcinol-formaldehyde resin and terephthaldehyde.

The adhesive composition T-5 is a control composition, of phenol-aldehyde type, as described in application WO2015/007641. This adhesive composition is based on phloroglucinol and furfuraldehyde.

The aqueous adhesive composition C-1 according to the invention is based on phloroglucinol and 5-(hydroxymethyl)furfural.

The aqueous adhesive composition C-2 according to the invention is based on a pre-condensed resorcinol-formaldehyde resin and 5-(hydroxymethyl)furfural.

The aqueous adhesive composition C-3 according to the invention is based on 1,3-benzenedimethanol and phloroglucinol.

These adhesive compositions C-1 to C-3 and T-1 to T-5 are furthermore all based on natural rubber (NR) latex, styrene/butadiene copolymer (SBR) latex and vinylpyridine/styrene/butadiene (VPSBR) latex.

### Adhesion Test

The polyamide (polyamide-6,6 or nylon-6,6) cords consist of folded yarns comprising two strands of 140×2 (count of each strand equal to 140 tex) and 250/250 (twist in t/m) construction; they were sized with each of these 6 aqueous adhesive compositions, C-1 to C-3 and T-1 to T-5, and then dried in a drying oven at 180° C. for 60 s. The adhesive composition was then crosslinked by passing the textile cords through a treatment oven at 230° C. for 60 s. The combination was then rendered integral by curing with a natural rubber composition by virtue of a vulcanization heat treatment, in order to form composite test specimens as described below.

The quality of the bonding between the rubber composition and the textile material is subsequently determined by a test in which the force necessary to extract sections of cords made of textile material from the vulcanized rubber composition is measured. This rubber composition is a conventional composition which can be used for the calendering of tyre carcass reinforcement textile plies, based on natural rubber, carbon black and standard additives.

More specifically, the vulcanizate is a rubber block consisting of two sheets measuring 200 mm by 4.5 mm and with a thickness of 3.5 mm, applied against each other before curing (the thickness of the resulting block is then 7 mm). It is during the production of this block that the textile cords (15 sections in total) are imprisoned between the two rubber sheets in the uncured state, an equal distance apart and while allowing a cord end to project out on either side of these sheets with a length sufficient for the subsequent tensile testing. The block comprising the cords is then placed in a suitable mould and then cured under pressure. The curing temperature and the curing time are adapted to the intended test conditions and left to the discretion of those skilled in the art; by way of example, in the present case, the block is cured at 160° C. for 15 min.

On conclusion of the curing, the test specimen, thus consisting of the vulcanized block and the 15 sections of cords, is placed between the jaws of a suitable tensile testing machine in order to make it possible to test each section individually, at a given rate and a given temperature (for example, in the present case, at 100 mm/min and 20° C.).

The adhesion levels are characterized by measuring the “tearing-out” force (denoted by Fₘₐₓ) for tearing the reinforcers out of the test specimen. A value greater than that for the control test specimen, arbitrarily set at 100, indicates an improved result, that is to say, a greater tearing-out force than that for the control test specimen. The results of the adhesion tests carried out on the test specimens are summarized in table 1.

It is observed that the textile cords sized with the adhesive compositions C-1 to C-3 according to the invention have a tearing-out force Fₘₐₓ that is particularly high and unexpected for those skilled in the art since it is less than the controls T-1 or T-3 but significant and sufficient for those skilled in the art for the compositions C-1 and C-3 and greater than the controls T-2 or T-4 for the composition C-2.

### Wettability Test

The wettability test is carried out according to standard ASTM D-1417-10. For each adhesive composition, the surface tension, expressed as millinewtons per metre (or dynes per centimetre), is measured. The higher the surface tension value, the less the adhesive composition is capable of properly spreading over the material that it is intended to coat. Conversely, the lower the surface tension value, the better the wettability of the adhesive composition.

A value greater than that of the test carried out using composition T-2, arbitrarily set at 100, indicates an improved result, that is to say, a greater wettability than that of the control composition. The results of the tests carried out on the adhesive compositions are summarized in table 1. The indication “NM” means that the measurement was not carried out.

Surprisingly, the wettability is significantly improved for the compositions C-1 and C-3 compared to those of the control compositions T-2 and T-3. The wettability of the composition C-2 is also significantly improved in comparison to that of the control composition T-3.

### Solubilization Test

The solubility of each adhesive composition was also tested according to the following protocol. Firstly, the adhesive composition was stirred at a given stirring speed by means of a conventional stirrer of magnetic stirrer bar type. In the absence of solubilization of the adhesive composition at this stirring speed, and by means of this conventional stirrer, the stirring speed was gradually increased. If, at the maximum stirring speed of the conventional stirrer, solubilization of the adhesive composition was not observed, then the adhesive composition was stirred at a given stirring speed by means of an Ultra-Turrax type stirrer.

The need to use an Ultra-Turrax type stirrer, and also the stirring speed required for the solubilization of the adhesive composition, are indicated in table 1 below. A low stirring speed is indicated by “+”. A moderate stirring speed is indicated by “++”. A high stirring speed is indicated by “+++”.

Compositions C-1 to C-3 are easier to solubilize and only require gentle stirring to dissolve them in water, whereas vigorous stirring is required for the control compositions T-3 or T-4 (for the control compositions T-1 and T-2, formaldehyde is readily water-soluble) to prevent the appearance of residues.

In conclusion, the results of these various tests clearly demonstrate that the adhesive compositions according to the invention constitute a highly advantageous alternative to the use of the adhesives of the prior art.

TABLE 1

| Adhesive compositions | T-1 | T-2 | T-3 | T-4 | T-5 | C-1 | C-2 | C-3 |
|---|---|---|---|---|---|---|---|---|
| Compound: | | | | | | | | |
| Formaldehyde (1) | 0.9 | 0.7 | — | — | | — | — | |
| 1,4-Benzenedicarboxaldehyde (2) | — | — | 1.2 | 1 | | — | — | |
| 1,3-Benzenedimethanol (3) | | | | | | | | 1.3 |
| Furfuraldehyde (4) | | | | | 0.9 | | | |
| 5-(Hydroxymethyl)furfural (5) | — | — | — | — | | 1.3 | 1.1 | |
| Polyphenol: | | | | | | | | |
| Resorcinol (6) | 1.7 | — | — | — | | — | — | |
| Phloroglucinol (7) | — | — | 1.4 | — | 1.7 | 1.3 | — | 1.3 |
| SRF 1524 (8) | — | 1.9 | — | 1.6 | | | 1.5 | |
| Sodium hydroxide (9) | 0.2 | 0.2 | 0.2 | 0.2 | 0.2 | 0.2 | 0.2 | 0.2 |
| Elastomer latex: | | | | | | | | |
| NR (10) | 6.4 | 6.4 | 6.4 | 6.4 | 6.4 | 6.4 | 6.4 | 6.4 |
| SBR (11) | 3.2 | 3.2 | 3.2 | 3.2 | 3.2 | 3.2 | 3.2 | 3.2 |
| VP-SBR (12) | 6.4 | 6.4 | 6.4 | 6.4 | 6.4 | 6.4 | 6.4 | 6.4 |
| Aqueous ammonia (13) | 0.5 | 0.5 | 0.5 | 0.5 | 0.5 | 0.5 | 0.5 | 0.5 |
| Total weight of solids of adhesive | 19.3 | 19.3 | 19.3 | 19.3 | 19.3 | 19.3 | 19.3 | 19.3 |
| composition | | | | | | | | |
| Weight of water | 80.7 | 80.7 | 80.7 | 80.7 | 80.7 | 80.7 | 80.7 | 80.7 |
| Adhesion tests | | | | | | | | |
| Fₘₐₓ at 20° C. | 100 | 100 | 94 | 95 | 78 | 92 | 106 | 87 |
| Wettability | NM | 100 | 79 | NM | 90 | 105 | 93 | 105 |
| Need to use an Ultra-Turrax | No | No | Yes | Yes | No | No | No | No |
| type mixer | | | | | | | | |
| Stirring speed | + | + | +++ | +++ | + | + | + | + |

(1) Formaldehyde (from Caldic; diluted to 36%);
(2) 1,4-Benzenedicarboxaldehyde (from ABCR; purity of 98%);
(3) 1,3-Benzenedimethanol (from Aldrich; purity of 99%);
(4) Furfuraldehyde;
(5) HMF;
(6) Resorcinol (from Sumitomo; purity of 99.5%);
(7) Phloroglucinol (from Alfa Aesar; purity of 99%);
(8) Pre-condensed resin SRF 1524 (from Schenectady; diluted to 75%);
(9) Sodium hydroxide (from Aldrich; diluted to 30%);
(10) NR Latex (“Trang Latex” from Bee tex; diluted to 61% by weight);
(11) SBR Latex (“Encord-201” from Jubilant; diluted to 41% by weight);
(12) Vinylpyridine/styrene/butadiene latex (“VP 106S” from Eliokem; diluted to 41%);
(13) Aqueous ammonia (from Aldrich; diluted to 21%).

1. An aqueous adhesive composition comprising (A) a thermosetting resin and (B) an unsaturated elastomer latex,
wherein the thermosetting resin is based on:
(A1) at least one aromatic compound comprising at least one aromatic ring bearing at least two functions, one of these functions being a hydroxymethyl function and the other being an aldehyde function or a hydroxymethyl function; and
(A2) at least one aromatic polyphenol comprising at least one aromatic ring bearing at least two hydroxyl functions in the meta position relative to one another, the two positions ortho to at least one of the hydroxyl functions being unsubstituted; and/or
(A2′) at least one aromatic monophenol comprising at least one six-membered aromatic ring bearing a single hydroxyl function, the two positions ortho to the hydroxyl function being unsubstituted, or at least one position ortho to and the position para to the hydroxyl function being unsubstituted.

2. The composition according to claim 1, wherein the aromatic compound A1 corresponds to the general formula (II): 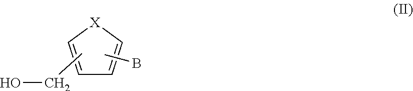
in which B represents CHO or CH₂OH, X represents O, NR₁, NO, S, SO, SO₂, SR₂R₃, R₁ represents a hydrogen, an alkyl, aryl, arylalkyl, alkylaryl or cycloalkyl group, R₂, R₃ each represent, independently of one another, a hydrogen, an alkyl, aryl, arylalkyl, alkylaryl or cycloalkyl group.

3. The composition according to claim 1, wherein the aromatic compound A1 corresponds to the general formula (II′a1) or (II′a2):

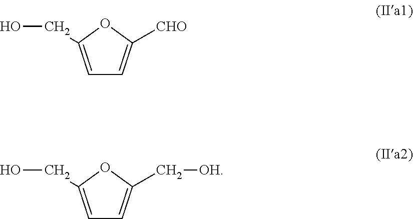

4. The composition according to claim 1, wherein the aromatic ring of the aromatic polyphenol bears three hydroxyl functions in the meta position relative to one another.

5. The composition according to claim 1, wherein the two positions ortho to each hydroxyl function on the aromatic ring of the aromatic polyphenol are unsubstituted.

6. The composition according to claim 1, in which the remainder of the aromatic ring of the aromatic polyphenol is unsubstituted.

7. The composition according to claim 1, wherein the aromatic polyphenol comprises several aromatic rings, at least two of these each bearing at least two hydroxyl functions in the meta position relative to one another, the two positions ortho to at least one of the hydroxyl functions of at least one aromatic ring being unsubstituted.

8. The composition according to claim 7, wherein at least one of the aromatic rings of the aromatic polyphenol bears three hydroxyl functions in the meta position relative to one another.

9. The composition according to claim 7, wherein the two positions ortho to each hydroxyl function of at least one aromatic ring of the aromatic polyphenol are unsubstituted.

10. The composition according to claim 7, wherein the two positions ortho to each hydroxyl function of each aromatic ring of the aromatic polyphenol are unsubstituted.

11. The composition according to claim 1, wherein each aromatic ring of the aromatic polyphenol is a benzene ring.

12. The composition according to claim 1, wherein the aromatic polyphenol is selected from the group consisting of resorcinol, phloroglucinol, 2,2′,4,4′-tetrahydroxydiphenyl sulfide, 2,2′,4,4′-tetrahydroxybenzophenone and the mixtures of these compounds, advantageously phloroglucinol.

13. The composition according to claim 1, wherein the aromatic polyphenol is a pre-condensed resin based on:
at least one aromatic polyphenol comprising at least one aromatic ring bearing at least two hydroxyl functions in the meta position relative to one another, the two positions ortho to at least one of the hydroxyl functions being unsubstituted, and
at least one compound capable of reacting with said aromatic polyphenol comprising at least one aldehyde function and/or a compound capable of reacting with said aromatic polyphenol comprising at least two hydroxymethyl functions borne by an aromatic ring.

14.-18. (canceled)

19. The composition according to claim 1, wherein the water content of the adhesive composition varies from 60 to 90% by weight.

20. The composition according to claim 1, wherein the total solids content of the adhesive composition represents between 10 and 40% by weight.

21. An aqueous adhesive solution comprising a pre-condensed thermosetting resin based on:
(A1) at least one aromatic compound comprising at least one aromatic ring bearing at least two functions, one of these functions being a hydroxymethyl function and the other being an aldehyde function or a hydroxymethyl function; and
(A2) at least one aromatic polyphenol comprising at least one aromatic ring bearing at least two hydroxyl functions in the meta position relative to one another, the two positions ortho to at least one of the hydroxyl functions being unsubstituted.

22.-24. (canceled)

25. The aqueous adhesive solution according to claim 21, wherein the water content of the aqueous adhesive solution is between 70 and 98% by weight.

26. (canceled)

27. A textile material, at least a portion of which is coated with an adhesive layer comprising an adhesive composition according to claim 1.

28.-32. (canceled)

33. A rubber composite reinforced with a textile material according to claim 27.

34. The rubber composite according to claim 33, wherein the rubber composite is a tire.

35. (canceled)
